(19) United States
(12) Patent Application Publication
(10) Pub. No.: US 2019/0076747 A1
(43) Pub. Date: Mar. 14, 2019

(54) Multi-Axis Controlled Toy System

(71) Applicants: Jeffrey C. Zachmann, Fergus Falls, MN (US); Carl J. Zachmann, Fergus Falls, MN (US)

(72) Inventors: Jeffrey C. Zachmann, Fergus Falls, MN (US); Carl J. Zachmann, Fergus Falls, MN (US)

(21) Appl. No.: 15/704,371

(22) Filed: Sep. 14, 2017

(51) Int. Cl. A63H 29/24; G09B 19/00; A63H 17/38; A63H 33/30

(52) U.S. Cl. CPC A63H 29/24; A63H 33/3072; A63H 17/38; G09B 19/00

(57) ABSTRACT

A multi-axis controlled toy system for moving an amusement object on a variable level table surface. The multi-axis controlled toy system generally includes a recess formed by surrounding perimeter walls for supporting the table surface. A first plurality of pulleys and a second plurality of pulleys are mounted on the perimeter walls. A first line and a second line are wound about the pulleys and around handwheel pulleys rotatably engaged with handwheels. The lines are attached to moving rods perpendicular to each other and extending through a sliding member. The amusement object is attached to the sliding member. The user rotates the handwheels to move the lines and thereby move the moving rods. The motion of the rods generates the motion of the sliding member and amusement object on the table surface.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a multi-axis controlled toy system for providing manual control over motion of a toy along multiple axes for amusement while teaching dexterity.

### Related Art

Any discussion of the related art throughout the specification should in no way be considered as an admission that such related art is widely known or forms part of common general knowledge in the field.

Devices designed to move objects in two dimensions are used in a variety of industries. For example, x-y plotters involve moving a pen or other marking device, typically using motors under remote control, in two-dimensions to create drawings. Such devices are not widely used in the toy industry. Some toys that employ a mechanism similar to an x-y plotter are available for drawing. The popular Etch-A-Sketch™ is an example of such known toys.

Drawing and marking toys using x-y mechanisms allow a child to draw an image. However, such toys do not provide a child with the opportunity to move objects or to perform self-actualized projects using the motion of an object. Even the drawings that are possible for a child are limited by the motion in two dimensions resulting in the child quickly losing interest in the toy.

There is a need in the art for a toy that allows a child to move an object in context to allow the child to perform projects in context allowing the child to exercise dexterity and imagination.

### SUMMARY

An example embodiment is directed to a multi-axis controlled toy system. The multi-axis controlled toy system includes a table surface with a variable level surface area mounted within a recess formed by surrounding perimeter walls. The toy system includes a pulley system for moving an object along multiple dimensions. A first plurality of pulleys is used to move the object in a first dimension, and a second plurality of pulleys is used to move the object in a second dimension. The pulleys in the pulley system may be mounted on the perimeter walls in a position above the table surface. A first line may be wound about the first plurality of pulleys and around a first handwheel pulley rotatably engaged with a first handwheel mounted on one of the perimeter walls to cause a linear motion of the first line when the first handwheel is rotated by a user. A second line may be wound about the second plurality of pulleys and around a second handwheel pulley rotatably engaged with a second handwheel mounted on one of the perimeter walls to cause a linear motion of the second line when the second handwheel is rotated by the user. A first moving rod extends across the table surface in a first direction. The first moving rod may be attached to the first line to move in a second direction perpendicular to the first direction when the first handwheel is rotated. A second moving rod extends across the table surface in the second direction. The second moving rod may be attached to the second line to move in the first direction when the second handwheel is rotated. An amusement object may be attached to a sliding member movably engaged with the first moving rod and the second moving rod. The sliding member moves the amusement object in response to motion of the first moving rod and the second moving rod and allows for vertical motion of the amusement object in response to level variations in the surface area of the table surface.

There has thus been outlined, rather broadly, some of the embodiments of the multi-axis controlled toy system in order that the detailed description thereof may be better understood, and in order that the present contribution to the art may be better appreciated. There are additional embodiments of the multi-axis controlled toy system that will be described hereinafter and that will form the subject matter of the claims appended hereto. In this respect, before explaining at least one embodiment of the multi-axis controlled toy system in detail, it is to be understood that the multi-axis controlled toy system is not limited in its application to the details of construction or to the arrangements of the components set forth in the following description or illustrated in the drawings. The multi-axis controlled toy system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a multi-axis controlled toy system in accordance with an example embodiment.

FIG. 2 is a side view of the multi-axis controlled toy system in FIG. 1.

FIG. 3 is a top view of an example implementation of a pulley system for use in an example implementation of the multi-axis controlled toy system in FIG. 1.

FIG. 4 is a top perspective view of the pulley system in FIG. 3.

FIG. 5 is a close-up perspective view of an example of an amusement object illustrating operation of the multi-axis controlled toy system in FIG. 1.

FIG. 6 is a close-up side view of the amusement object in FIG. 5 illustrating vertical play when the amusement object moves over a variable level surface.

### DETAILED DESCRIPTION

### A. Overview

An example multi-axis controlled toy system generally implemented as a table having a table surface with a variable level surface area mounted within a recess formed by surrounding perimeter walls. The toy system includes an amusement object, which may be in the form of a vehicle, such as, for example, a truck or an automobile, or tools where the vehicle or tools conform to a context provided by a topography formed on the surface of the table. If the toy is a vehicle, a truck for example, the surface of the table surface may be formed as hills or mounds of sand, and the user may move the truck to move the sand or rocks using handwheels mounted on a wall. If the toy is a tool, such as for example, a shovel or rake, the user may use the tool on a topography formed as a landscape or a garden. If the toy is a 4×4 or a car, the surface of the table may included a molded course on which the user can “drive” the vehicle. The user can exercise dexterity and self-actualize projects in the context of the topography on the surface of the table.

In an example implementation, a sliding member is slidably engaged with two perpendicular moving rods, a first moving rod and a second moving rod. The first moving rod extends across the table surface along a first axis and the second moving rod extends across the table surface along a second axis perpendicular to the first axis. The first moving rod is configured to move in either direction perpendicular to the first axis. The second moving rod is configured to move in either direction perpendicular to the second axis.

A first line and a second line extend around corresponding pulley systems that include corresponding handwheel pulleys rotatably engaged with corresponding handwheels. The pulleys may be mounted in or near corners formed by the perimeter walls at positions above the table surface. The first line is wound around the first handwheel pulley and extends to wind around a first pulley system so that two portions of the line extend across the table surface at opposite sides of the table surface and move in the same direction when a user rotates the first handwheel. The first moving rod is attached at opposite ends to the two portions of the first line. The second line is wound around the second handwheel pulley and extends to wind around the second pulley system so that two portions of the second line extend across the table surface at opposite sides of the table surface perpendicular to the two portions of the first line. The second line winds around the pulleys so that the two portions on opposite sides move in the same direction (perpendicular to the two portions of the first line) when the user rotates the second handwheel. The second moving rod is attached at opposite ends of the moving rod to the two portions of the second line so that the two moving rods extend across the table perpendicular to each other with the sliding member slidably engage with the two moving rods substantially at the point where the two moving rods cross.

The user rotates the first handwheel to move the first moving rod in a direction parallel to the second axis, and rotates the second handwheel to move the second moving rod in a direction parallel to the second axis. The direction of rotation of the handwheel determines the direction in which the moving rod moves. The rotation of the two handwheels moves the moving members, which then move the sliding member in a plane parallel to the table surface. Each moving rod slides through a through-hole in the sliding member to permit the motion along the axis of the moving rod when the other moving rod is pushing on the sliding member. A vertical rod extends from the sliding member to movably engage with the amusement object and to move the toy as the sliding member moves on the table surface.

The table surface may have a variable level, which may be formed using materials such as sand, dirt, rocks, gravel, miniature roads and hills formed by molded plastic, or any other suitable contouring mechanism. The toy may be engaged with the sliding member in a manner that allows the toy to move vertically as the level of the surface of the table surface varies across the table surface.

### B. Multi-Axis Controlled Toy System

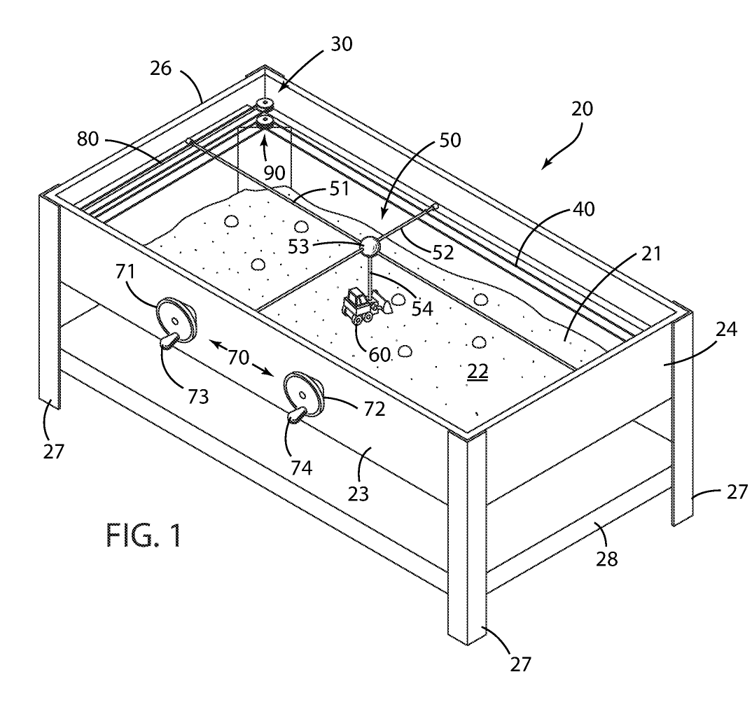

FIG. 1 is a perspective view of a multi-axis controlled toy system 20 in accordance with an example embodiment. Referring to FIG. 1, the multi-axis controlled toy system 20 includes a table surface 21, a pulley system 30, first line 40, a second line 80, an object moving apparatus 50, handwheel controllers 70, and an amusement object 60. The multi-axis controlled toy system 20 may be implemented as a table in which the table surface 21 provides the play environment in which a user, such as a child, can move the amusement object 60 in the area of the table surface 21. The table surface may be supported by multiple table supports 27. A shelf 28 may be provided at a level below the table surface 21 for holding objects in a storing place.

The table surface 21 includes a variable level surface area 22 mounted within a recess formed by surrounding perimeter walls. The example shown in FIGS. 1 through 3 includes four perimeter walls, a front wall 23, a first side wall 24, a back wall 25, and a second side wall 26. The front wall 23, the side walls 24 and 26, and the back wall 25 in FIG. 1 are configured to form a rectangular table structure forming four corners between the walls. The corners may include corner ledges as shown at 90 to provide a surface on which the pulleys in the pulley system 30 may be mounted.

The front wall 23, back wall 24, and side walls 24 and 26 may be configured to extend vertically to a level above the table surface 21 each wall 23, 24, 25, and 26 terminating at an upper edge above the stable surface 21. In an example implementation, the upper edges of each wall 23, 24, 25, and 26 are at substantially the same level and may be configured to support a transparent table top (not shown) enabling the multi-axis controlled toy system 20 to serve as a table.

In an example implementation, the first line 40 and the second line 80 are wound around corresponding pulleys in the pulley system 30 and around handwheel pulleys rotatably engaged with the handwheel controllers 70. The example shown in FIG. 1 shows the handwheel controllers 70 include a first handwheel 71 and a second handwheel 72. The first line 40 may be wound thorough the pulley system 30 so that the user causes the first line 40 to move linearly when the user turns the first handwheel 71. Similarly, the second line 80 may be wound through the pulley system 30 so that the user causes the second line 80 to move linearly when the user turns the second handwheel 72.

The object moving system 50 in FIG. 1 includes a first moving rod 51 extending across the table surface 21 along a first axis and a second moving rod 52 extending across the table surface 21 along a second axis perpendicular to the first axis. The first moving rod 51 is attached to the first line 40 so that the first line 40 moves the first moving rod 51 in a direction perpendicular to the first axis when the user rotates the first handwheel 71. The second moving rod 52 is attached to the second line 80 so that the second line 80 moves the second moving rod 52 in a direction perpendicular to the second axis when the user rotates the second handwheel 72.

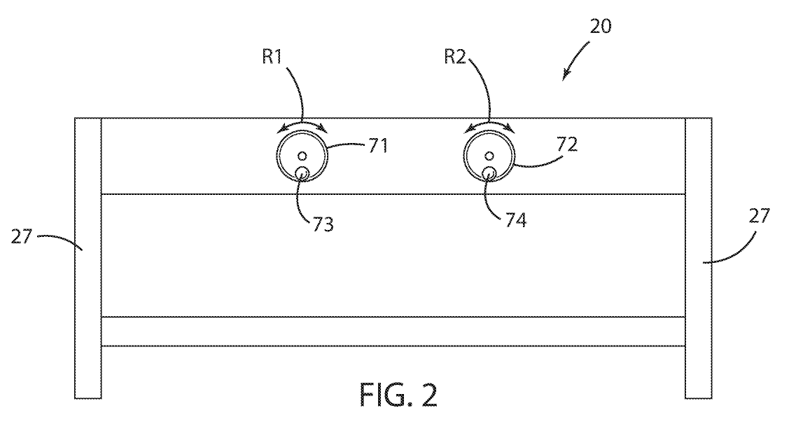

FIG. 2 is a side view of the multi-axis controlled toy system 20 in FIG. 1, which shows the front wall 23 supported by table supports 27. The handwheel controllers 70 include a first handwheel 71 and a second handwheel 72 mounted on the outer surface of the front wall 23. The first handwheel 71 optionally includes a first gripping member 73 and the second handwheel 72 optionally includes a second gripping member 74. The first gripping member 73 and the second gripping member 74 extend from the first handwheel 71 and the second handwheel 72, respectively, to provide the user with a mechanism to rotate the first handwheel 71 and the second handwheel 72, respectively, as indicated by the curved arrows R1 and R2 with double-arrowheads above the first handwheel 71 and the second handwheel 72, respectively.

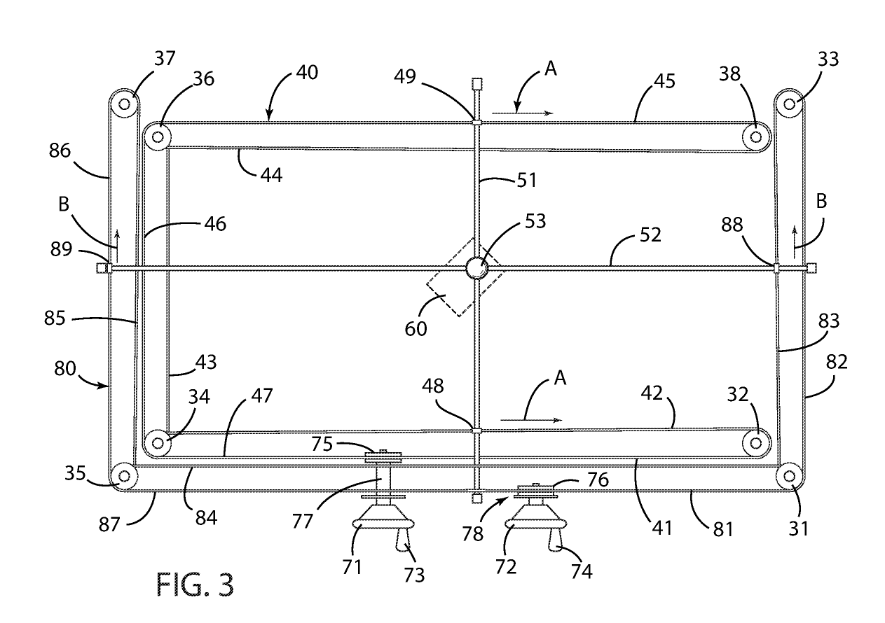

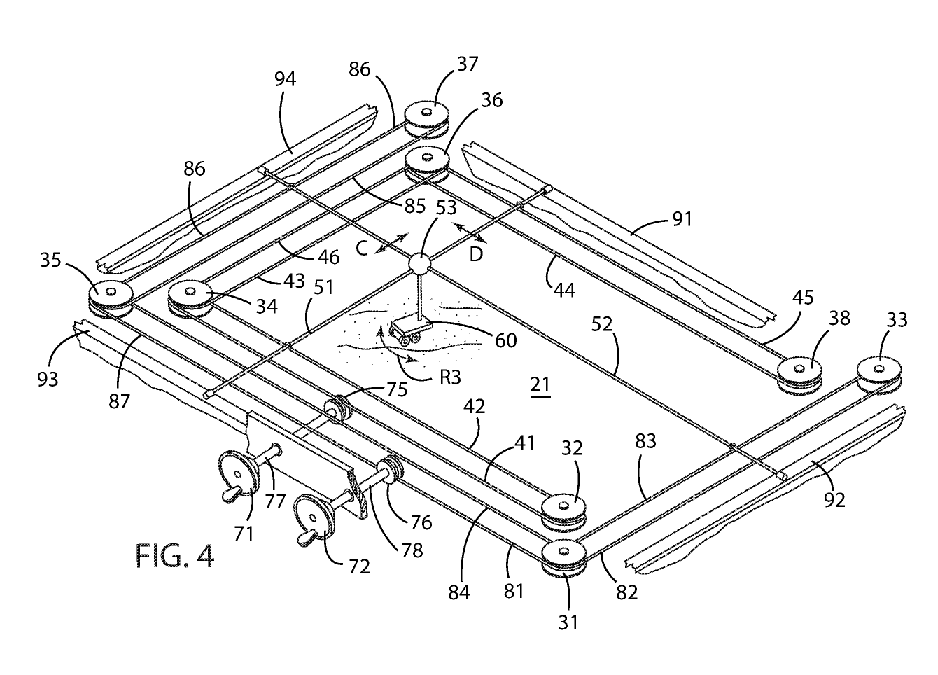

FIG. 3 is a top view of an example implementation of a pulley system 30 for use in an example implementation of the multi-axis controlled toy system 20 in FIG. 1. FIG. 4 is a top perspective view of the pulley system 30 in FIG. 3. Referring to FIGS. 3 and 4, in an example implementation, the pulley system 30 includes a first plurality of pulleys 32, 34, 36, 38 and a second plurality of pulleys 31, 33, 35, 37 mounted on the perimeter walls 23, 24, 25, 26 above the table surface 21.

The first line 40 is wound around the first plurality of pulleys 32, 34, 36, 38 and around a first handwheel pulley 75 rotatably engaged with the first handwheel 71. The first handwheel 71 may be attached to the first handwheel pulley 75 by a first handwheel shaft 77 with a length sufficient to position the first handwheel pulley 75 in line with the first line 40. The second handwheel 72 may be attached to the second handwheel pulley 76 by a second handwheel shaft 78 with a length sufficient to position the second handwheel pulley 76 in line with the second line 80. The user rotates the first handwheel 71 to rotate the first handwheel pulley 75, which causes a linear motion (indicated by arrows A in FIG. 3) of the first line 40. The linear motion at A of the first line 40 extends through each one of the first plurality of pulleys 32, 34, 36, 38 switching directions according to the manner in which the first line 40 winds around each of the first plurality of pulleys 32, 34, 36, 38. The linear motion at A of the first line 40 extends around the each of the first plurality of pulleys 32, 34, 36, 38 to portions of the first line 40 that are attached to opposite ends of the first moving rod 51. The portions to which the first moving rod 51 attaches move in the same direction with the motion of the first line 40.

The second line 80 is wound about the second plurality of pulleys 31, 33, 35, 37 and around a second handwheel pulley 76 rotatably engaged with the second handwheel 72. The user rotates the second handwheel 72 to rotate the second handwheel pulley 76, which causes a linear motion (indicated by arrows B in FIG. 3) of the second line 80. The linear motion at B of the second line 80 extends through each one of the second plurality of pulleys 31, 33, 35, 37 switching directions according to the manner in which the second line 80 winds around each of the second plurality of pulleys 31, 33, 35, 37. The linear motion at B of the second line 80 extends around each of the second plurality of pulleys 31, 33, 35, 37 to portions of the second line 80 that are attached to opposite ends of the second moving rod 52. The portions to which the second moving rod 52 attaches move in the same direction with the motion of the second line 80.

The front perimeter wall 23 (in FIG. 1) may be formed with a first ledge 91 and the back perimeter wall 25 (in FIG. 1) may be formed with a second ledge 93. The first moving rod 51 may extend across the table surface 21 to rest at one end on the first ledge 91 and at the opposite end on the second ledge 93. The ends of the first moving rod 51 may slide or roll on the first ledge 91 and the second ledge 93 when the first moving rod 51 is moved over the table surface 21. The first side perimeter wall 24 (in FIG. 1) may be formed with a third ledge 92 and the second side perimeter wall 26 may be formed with a fourth ledge 94. The second moving rod 52 may extend across the table surface 21 to rest at one end on the third ledge 92 and at the opposite end on the fourth ledge 94. The ends of the second moving rod 52 may slide or roll on the third ledge 92 and the fourth ledge 94 when the second moving rod 52 is moved over the table surface 21.

FIGS. 3 and 4 illustrate one example implementation of the pulley systems and the manner in which the first line and the second line may be wound through the pulleys. As shown in FIGS. 3 and 4, the first line 40 extends from the first handwheel pulley 75 in a first portion 41 of the first line 40 to wind about a first pulley 32 in the first plurality of pulleys. The first line 40 may be a monofilament line or another similar string-like element capable of moving with the rotation of the first handwheel pulley 75 due to friction between the first line 40 and the first handwheel pulley 75.

From the first handwheel pulley 75, the first line 40 extends in a second portion 42 of the first line 40 in parallel and in a direction opposite the first portion 41 of the first line 40 to wind around a second pulley 34 in the first plurality of pulleys. The first line 40 then extends in a third portion 43 of the first line 40 after wrapping around the second pulley 34 to extend in a direction perpendicular to the second portion 42 of the first line 40 to wind around a third pulley 36 in the first plurality of pulleys. The first line 40 then extends in a fourth portion 44 of the first line 40 in a direction perpendicular to the third portion 43 of the first line 40 to wind about a fourth pulley 38 in the first plurality of pulleys. The first line 40 then extends in a fifth portion 45 of the first line 40 in parallel and in a direction opposite the fourth portion 44 of the first line 40 to wind about the third pulley 36 in the first plurality of pulleys. The first line 40 then extends in a sixth portion 46 of the first line 40 in parallel and in a direction opposite the third portion 43 of the first line 40 to wind about the second pulley 34 in the first plurality of pulleys. The first line 40 then extends in a seventh portion 47 of the first line 40 to join the first portion 41 of the first line 40 at the first handwheel pulley 75. The first moving rod 51 attaches at a first end attachment point 48 of the first moving rod 51 to the second portion 42 of the first line 40. The first moving rod 51 attaches at a second end attachment point 49 opposite the first end attachment point 48 of the first moving rod 51 to the fifth portion 45 of the first line 40.

The second portion 42 and the fifth portion 45 of the first line 40 each move in the same direction (indicated by arrows A in FIG. 3) when the user rotates the first handwheel 71 clockwise or counter-clockwise depending on the direction the first line 40 is wound around the first handwheel pulley 75. When the user rotates the first handwheel 71 in the counter-clockwise or clockwise direction opposite the direction of rotation for the example shown in FIG. 3, the second portion 42 and the fifth portion 45 of the first line 40 move in a direction opposite that direction of the arrows A in FIG. 3.

As shown in FIGS. 3 and 4, the second line 80 extends from the second handwheel pulley 76 in a first portion 81 of the second line 80 to wind about a first pulley 31 in the second plurality of pulleys. As with the first line 40, the second line 80 may be a monofilament line or another similar string-like element capable of moving with the rotation of the second handwheel pulley 76 due to friction between the second line 80 and the second handwheel pulley 76.

From the second handwheel pulley 76, the second line 80 extends in a second portion 82 of the second line 80 in a direction perpendicular to the first portion 81 of the second line 80 to wind about a second pulley 33 in the second plurality of pulleys. The second line 80 extends in a third portion 83 of the second line 80 to wind around the first pulley 31 in the second plurality of pulleys. The second line 80 then extends in a fourth portion 84 of the second line 80 in a direction parallel and opposite the first portion 81 of the second line 80. The second line 80 winds around a third pulley 35 in the second plurality of pulleys. The second line 80 extends in a fifth portion 85 of the second line 80 in a direction perpendicular to the fourth portion 84 of the second line 80 to wind about a fourth pulley 37 in the second plurality of pulleys. The second line 80 then extends in a sixth portion 86 of the second line 80 in parallel and in a direction opposite the fifth portion 85 of the second line 80 to wind about the third pulley 35 in the second plurality of pulleys. The second line 80 then extends in a seventh portion 87 of the second line 80 to join the first portion 81 of the second line 80 at the second handwheel pulley 76.

The third portion 83 and the sixth portion 86 of the second line 80 each move in the same direction (indicated by arrows B in FIG. 3) when the user rotates the second handwheel 72 clockwise or counter-clockwise depending on the direction the second line 80 is wound around the second handwheel pulley 76. When the user rotates the second handwheel 72 in the counter-clockwise or clockwise direction opposite the direction of rotation for the example shown in FIG. 3, the third portion 83 and the sixth portion 86 of the second line 80 move in a direction opposite the direction of the arrows B in FIG. 3.

It is noted that the pulley system 30 shown in FIGS. 3 and 4 is one example implementation of a pulley system for moving the amusement object 60 on the table surface 21. The pulley system may include a different number of pulleys, and the first line 40 and the second line 80 may be wound around the pulleys in a different manner than that illustrated in FIGS. 3 and 4. It is noted that in the example implementation shown in FIGS. 3 and 4, single pulleys are used where a line winds around the pulley and about the same pulley. In one alternative implementation, pulleys may be stacked so that a line only winds around or about each pulley, but not both. The second pulley 34 and the third pulley 36 in the first plurality of pulleys, for example, may be replaced with stacked pulleys where the first line 40 winds around one of the stacked pulleys between the second portion 42 and the third portion of the first line 40 and the first line 40 winds about the other one of the stacked pulleys between the sixth portion 46 and the seventh portion of the first line 40.

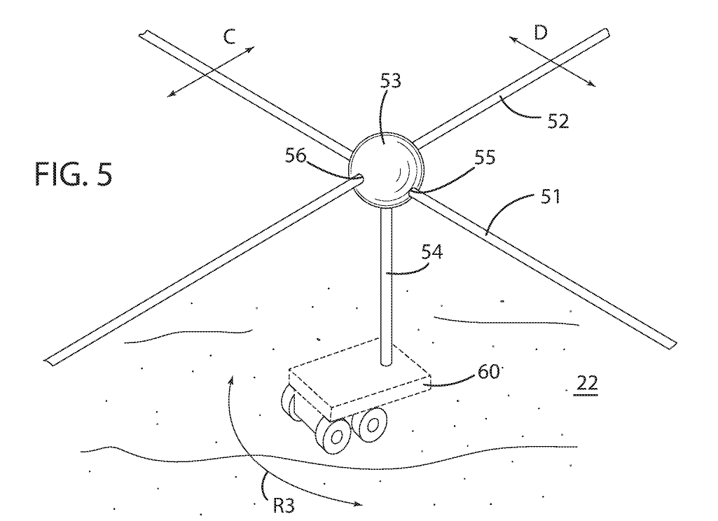

FIG. 5 is a close-up perspective view of an example of the amusement object 60 illustrating operation of the multi-axis controlled toy system in FIG. 1. Referring to FIGS. 4 and 5, the sliding member 53 is movably engaged with the first moving rod 51 to slide axially along the first moving rod 51. The slidable engagement with the first moving rod 51 is implemented by a first through-hole 55 through the sliding member 53 along the first axis of the first moving rod 51. The extension of the first moving rod 51 through the first through-hole 55 allows the sliding mechanism 53 to slide on the first moving rod 51 in response to movement of the second moving rod 52. The second moving rod 52 is moved as described above with reference to FIGS. 3 and 4 in a direction perpendicular to the first moving rod 51 as indicated by double-headed arrow C.

The sliding member 53 is also movably engaged with the second moving rod 52 to slide axially along the second moving rod 52 The slidable engagement with the second moving rod 52 is implemented by a second through-hole 56 through the sliding member 53 along the second axis of the second moving rod 52. The extension of the second moving rod 52 through the second through-hole 56 allows the sliding mechanism 53 to slide on the second moving rod 52 in response to movement of the first moving rod 51 in a direction perpendicular to the second moving rod 52 as indicated by double-headed arrow D.

The amusement object 60 is attached to the sliding member 53 by the vertical rod 54. As the sliding member 53 is moved on a plane above the table surface 21, the amusement object 60 moves accordingly on the table surface 21. In an example implementation, the vertical rod 54 attaches to the amusement object 60 in a manner that allows the user to move the sliding mechanism 53 so that the amusement object 60 rotates around the vertical rod 54 on the table surface 21 as indicated by curved arrow R3. The vertical rod 54 also attaches to the amusement object 60 with a vertical freedom of movement so that the amusement object 60 moves vertically in response to changes in the level of the table surface 21.

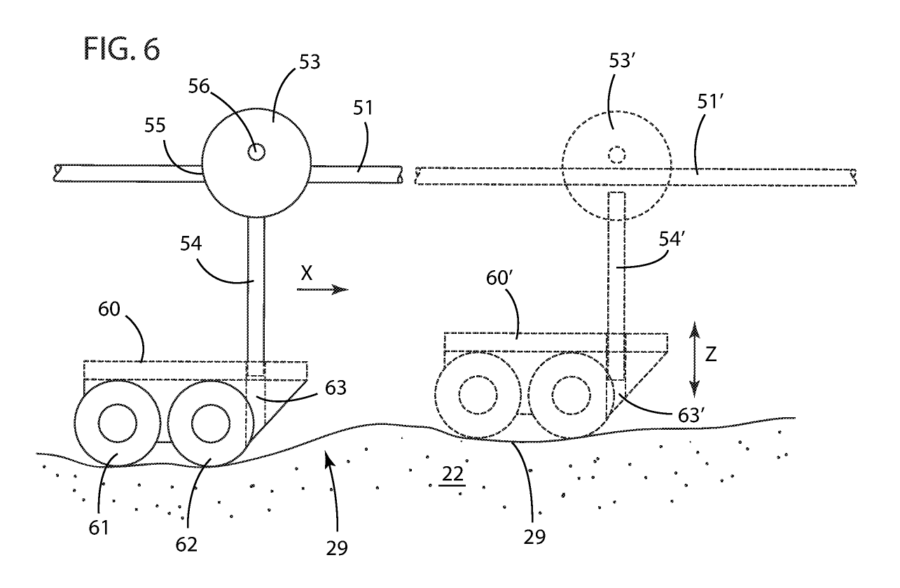

FIG. 6 is a close-up side view of the amusement object 60 in FIG. 5 illustrating an example implementation of the engagement of the vertical rod 54 with the amusement object 60 so as to allow the amusement object 60 to move vertically over a variable level surface 22. The amusement object 60, a vehicle 60 in the example shown in FIGS. 4-6, is shown moving in a direction indicated by arrow X approaching a change 29 in the level of the variable level surface 22. The vehicle 60 includes a first pair of wheels 61, a second pair of wheels 62, and a vertical through-hole 63. The vertical rod 54 is configured to attach to the sliding member 53 and to enter the vertical through-hole 63 on the vehicle 60. The vertical rod 54 slides in the vertical through-hole 63 as the vehicle 60 moves over the variable level surface 29.

FIG. 6 shows a second representation of the vehicle 60′, the sliding member 53′, the first moving rod 51′, the vertical rod 54′, each having dashed outline to represent the vehicle 60′ in a different position at the change 29 in the level of the variable level surface area 22. The vertical rod 54′ extending into the second representation of the vehicle 60′ is shown to extend deeper into the vertical through-hole 63′ due to the vertical movement of the vehicle 60′ indicated by double-headed arrow Z. The vertical through-hole 63 is configured to have a vertical length sufficient to enable the vertical rod 54 to stay within the vertical through hole 63 as the vehicle 60 moves on the variable level surface 29. The vertical rod 54 may be configured with structure at the lower end of the vertical rod 54 and the vertical through-hole 63 may be configured at an upper edge with structure that keeps the vertical rod 54 engaged with the vehicle 60.

### C. Operation of Preferred Embodiment

Referring back to FIG. 1, in use, a user, typically a child, operates the multi-axis controlled system 20 (in FIG. 1) by rotating the handwheels 71 and 72 to move the amusement object 60. Rotation of the handwheels 71 and 72 generates a linear motion in the first line 40 and the second line 80, respectively. The motion of the first line 40 and the second line 80 is transferred to the first moving rod 51 and the second moving rod 52, respectively. The motion of the first moving rod 51 and the second moving rod 52 causes the sliding member 53 to move along a plane above the table surface 21.

The multi-axis controlled toy system 20 (in FIG. 1) may be provided with a model topography configured to vary the level 29 (in FIG. 6) of the surface area 22 of the table surface 21 while providing a context for the user to move the vehicle 60. For example, the model topography may be formed using at least one material including sand, dirt, rocks, molded plastic, wood, metal and any combination thereof. The model topography may then provide the user with a context corresponding to moving sand, dirt, rocks, or any other objects using the vehicle 60.

In another implementation, the amusement object 60 may be a toy tool configured to perform tasks related to at least one toy object disposed on the surface area 22 of the table surface 21. For example, the amusement object 60 may be comprised of various types of toys including, but not limited to, a toy vehicle (e.g. tractor, skid-steer tractor, front end loader tractor, tractor grader, dirt hauling truck, truck, earth moving equipment), toy tools (e.g. a rake, a shovel) or any other toy object to be manipulated for enjoyment. The at least one toy object may include a garden, a sand pile, a dirt pile, a toy tree, a toy and the like. Unless otherwise defined, all technical and scientific terms used herein have the same meaning as commonly understood by one of ordinary skill in the art to which this invention belongs. Although methods and materials similar to or equivalent to those described herein can be used in the practice or testing of the multi-axis controlled toy system, suitable methods and materials are described above. All publications, patent applications, patents, and other references mentioned herein are incorporated by reference in their entirety to the extent allowed by applicable law and regulations. The multi-axis controlled toy system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A multi-axis controlled toy system comprising:
a table surface having a variable level surface area mounted within a recess formed by surrounding perimeter walls;
a first plurality of pulleys and a second plurality of pulleys mounted on the perimeter walls above the table surface;
a first line wound about the first plurality of pulleys and around a first handwheel pulley rotatably engaged with a first handwheel mounted on one of the perimeter walls to cause a linear motion of the first line when the first handwheel is rotated by a user;
a second line wound about the second plurality of pulleys and around a second handwheel pulley rotatably engaged with a second handwheel mounted on one of the perimeter walls to cause a linear motion of the second line when the second handwheel is rotated by the user;
a first moving rod extending across the table surface along a first axis, the first moving rod attached to the first line to move in a direction perpendicular to the first axis when the first handwheel is rotated;
a second moving rod extending across the table surface along a second axis, the second moving rod attached to the second line to move in a direction perpendicular to the second axis when the second handwheel is rotated;
a sliding member movably engaged with the first moving rod and the second moving rod to move in response to the motion of the first moving rod and the second moving rod; and
an amusement object movably attached to the sliding member to allow vertical motion of the amusement object in response to level variations in the surface area of the table surface and to allow horizontal motion on the table surface in response to the motion of the moving rods.

2. The multi-axis controlled toy system of claim 1 where the amusement object includes a vertical through-hole opening to receive a vertical rod attached to the sliding member, the vertical through-hole having a vertical length within the amusement object sufficient to enable a lower end of the vertical rod to move vertically within the vertical through-hole in response to level variations in the surface area of the table surface.

3. The multi-axis controlled toy system of claim 1, wherein the amusement object is a vehicle configured to move responsive to movement of the sliding member on the surface area of the table surface.

4. The multi-axis controlled toy system of claim 3, further comprising a model topography configured to vary the level of the surface area of the table surface while providing a context for the user to move the vehicle.

5. The multi-axis controlled toy system of claim 4, wherein the model topography is formed using at least one material including sand, dirt, rocks, molded plastic, wood, metal and any combination thereof.

6. The multi-axis controlled toy system of claim 3, wherein the amusement object is a toy tool configured to perform tasks related to at least one toy object disposed on the surface area of the table surface.

7. The multi-axis controlled toy system of claim 1, wherein the sliding member is a three-dimensional object having a first through-hole for the first moving rod to slide therethrough and a second through-hole extending perpendicular to the first through-hole for the second moving rod to slide therethrough.

8. The multi-axis controlled toy system of claim 7, wherein the three-dimensional object includes a downward extending rod attached at an opposite end to the amusement object.

9. The multi-axis controlled toy system of claim 1, wherein the table surface is surrounded by four perimeter walls arranged in a rectangular shape.

10. The multi-axis controlled toy system of claim 9, wherein the first handwheel and the second handwheel are mounted on an external surface of a first of the four perimeter walls.

11. The multi-axis controlled toy system of claim 10, further comprising:
a first handwheel shaft connecting the first handwheel to the first handwheel pulley; and
a second handwheel shaft connecting the second handwheel to the second handwheel pulley.

12. The multi-axis controlled toy system of claim 9 wherein:
the first plurality of pulleys includes four pulleys mounted substantially in the corners formed by the four perimeter walls; and
the first line winds around the first handwheel pulley to turn with a rotation of the first handwheel without substantial slippage and extends around the four pulleys such that two portions of the first line extend across the table surface at opposite sides of the table surface and such that the two portions move in the same direction responsive to the rotation of the first handwheel pulley.

13. The multi-axis controlled toy system of claim 12 wherein:
the first line extends from the first handwheel pulley in a first portion of the first line to wind about a first one of the first plurality of pulleys to extend in a second portion of the first line in parallel and in a direction opposite the first portion of the first line to wind around a second one of the first plurality of pulleys, extending in a third portion of the first line in a direction perpendicular to the second portion of the first line to wind around a third one of the first plurality of pulleys to extend in a fourth portion of the first line in a direction perpendicular to the third portion of the first line to wind about a fourth one of the first plurality of pulleys to extend in a fifth portion of the first line in parallel and in a direction opposite the fourth portion of the first line to wind about the third one of the first plurality of pulleys to extend in a sixth portion of the first line in parallel and in a direction opposite the third portion of the first line to wind about the second one of the first plurality of pulleys to extend in a seventh portion of the first line to join the first portion of the first line at the first handwheel pulley, and
the first moving rod is attached at one end to the second portion of the first line and at an opposite end to the fifth portion of the first line.

14. The multi-axis controlled toy system of claim 9 wherein:
the second plurality of pulleys includes four pulleys mounted substantially in the corners formed by the four perimeter walls; and
the second line winds around the second handwheel pulley to turn with a rotation of the second handwheel without substantial slippage and extends around the four pulleys such that two portions of the second line extend across the table surface at opposite sides of the table surface and such that the two portions move in the same direction responsive to the rotation of the second handwheel pulley.

15. The multi-axis controlled toy system of claim 14 wherein:
the second line extends in a first portion of the second line to wind about a first one of the second plurality of pulleys to extend in a second portion of the second line in a direction perpendicular to the first portion of the second line to wind about a second one of the second plurality of pulleys extending in a third portion of the second line to wind around the first one of the second plurality of pulleys extending in a fourth portion of the second line in a direction parallel and opposite the first portion of the second line, winding around a third one of the second plurality of pulleys to extend in a fifth portion of the second line in a direction perpendicular to the fourth portion of the second line to wind about a fourth one of the second plurality of pulleys, extending in a sixth portion of the second line in parallel and in a direction opposite the fifth portion of the second line to wind about the third one of the second plurality of pulleys to extend in a seventh portion of the second line to join the first portion of the second line at the second handwheel pulley, and
the second moving rod is attached at one end to the third portion of the second line and at an opposite end to the sixth portion of the second line.

16. The multi-axis controlled toy system of claim 9 where the four perimeter walls comprise:
a first wall having a first ledge opposite a second wall having a second ledge substantially level with the first ledge;
a third wall having a third ledge opposite a fourth wall having a fourth ledge substantially level with the third ledge; and
wherein:
a first end of the first moving rod is movably mounted on the first ledge;
a second end of the first moving rod is movably mounted on the second ledge;
a first end of the second moving rod is movably mounted on the third ledge; and
a second end of the second moving rod is movably mounted on the fourth ledge.

17. The multi-axis controlled toy system of claim 1 where:
the perimeter walls include four walls formed in a rectangular shape to form four corners;
the first plurality of pulleys includes four pulleys, each pulley mounted on one of a first set of corner ledges formed in each corner substantially level with one another.

18. The multi-axis controlled toy system of claim 17 where:
the second plurality of pulleys includes four pulleys, each pulley mounted on one of a second set of corner ledges formed in each corner substantially level with one another and at a different level from the first set of corner ledges.

19. The multi-axis controlled toy system of claim 1 where the perimeter walls extend to upper edges of the perimeter walls above the recessed table surface, the table further comprising:
a transparent table surface mounted on the upper edges of the perimeter walls to enable viewing of the amusement object as a user moves the amusement object in the surface area of the table surface.

20. The multi-axis controlled toy system of claim 1 where the first handwheel and the second handwheel each include a grip rod extending out from the first handwheel and the second handwheel to allow the user to rotate the handwheel.
